(19) United States
(12) Patent Application Publication
(10) Pub. No.: US 2020/0106253 A1
(43) Pub. Date: Apr. 2, 2020

(54) CLAMP, PATH-REGULATING MEMBER, AND WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Tomoya KAWAGUCHI, Yokkaichi (JP); Yuichi KIMOTO, Yokkaichi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/497,822

(22) PCT Filed: Mar. 23, 2018
(86) PCT No.: PCT/JP2018/011709

§ 371 Date: Sep. 26, 2019

(30) Foreign Application Priority Data
Mar. 30, 2017 (JP) 2017-067433

(51) Int. Cl. H02G 3/34; H02G 3/04; B60R 16/02

(52) U.S. Cl. CPC H02G 3/34; B60L 50/66; B60R 16/0215; H02G 3/0468

(57) ABSTRACT

A clamp that is to be used as a constituent member of a wire harness, the wire harness including wires, a sheathing material that is flexible and covers the wires, and a path regulator for regulating a path along which the wires are laid out from outside of the sheathing material, the path regulator having an axial direction parallel to the path along which the wires are laid out, the clamp including: a support with a ring-shaped structure for supporting the path regulator, wherein the ring-shaped structure of the support is configured to restrict rotation of the path regulator around an axis thereof and to allow relative movement of the path regulator and the clamp in the axial direction by fitting to a protrusion or a recess of the path regulator.

### BACKGROUND

The present disclosure relates to a clamp, a path-regulating member, and a wire harness.

As disclosed in JP 2011-155763A, a wire harness is known that includes a frame member for regulating a path along which wires are laid out, from the outside of a corrugated tube for protecting the wires.

### SUMMARY

As mentioned above, the path of the wires that are protected by a flexible sheathing material, such as a corrugated tube, can be regulated by connecting the sheathing material to a path-regulating member (frame member). A clamp is used to connect the path-regulating member to the sheathing material and to connect the path-regulating member to a vehicle. Here, there may be cases where the path-regulating member, which is supported by a support portion of the clamp, rotates around the axis thereof. If the path-regulating member thus rotates relative to the support portion, for example, the support portion may be more easily worn, and then, there is concern that the path-regulating member will be supported unstably by the clamp.

An exemplary aspect of the disclosure provides a clamp, a path-regulating member, and a wire harness that enable the path-regulating member for regulating the path of the sheathing material to be supported stably.

A clamp according to an exemplary aspect is a clamp that is to be used as a constituent member of a wire harness, the wire harness including wires, a sheathing material that is flexible and covers the wires, and a path-regulator for regulating a path along which the wires are laid out from outside of the sheathing material, the path-regulator having an axial direction parallel to the path along which the wires are laid out, the clamp including: a support with a ring-shaped structure for supporting the path-regulator, wherein the ring-shaped structure of the support is configured to restrict rotation of the path-regulator around an axis thereof by fitting to a protrusion or a recess of the path regulator.

According to this configuration, rotation of the path-regulator around the axis thereof relative to the support of the clamp is restricted.

In the above clamp, it is preferable that the ring-shaped structure has an insertion that enables the path-regulator to be inserted therefrom in a radial direction of the ring-shaped structure.

According to this configuration, the path-regulator can be supported by inserting an intermediate portion of the path-regulator into the support.

In the above clamp, it is preferable that the ring-shaped structure has a protrusion to be fitted to the recess of the path-regulator, and the protrusion has a pair of outer side faces that are separate from each other in a circumferential direction of the ring-shaped structure, and a leading end face continuous with the pair of outer side faces, and an angle formed by one of the pair of outer side faces and the leading end face is greater than an angle formed by the other one of the outer side faces and the leading end face.

According to this configuration, when the protrusion of the support is fitted to the recess of the path-regulator by relatively rotating the clamp and the path-regulator with respect to each other, one outer side face guides the path-regulator in a direction in which the protrusion of the support is inserted into the recess of the path-regulator. Thus, an operation to fit the protrusion of the support into the recess of the path-regulator is facilitated.

In the above clamp, it is preferable that a corner between an end face constituting at least one of two ends forming the insertion of the ring-shaped structure and an inner-circumferential face of the ring-shaped structure is chamfered.

According to this configuration, when the clamp and the path-regulator are relatively rotated to move the insertion so as to proceed over the protrusion of the path-regulator, an inclined face of the support comes into sliding contact with the protrusion of the path-regulator, thereby facilitating expansion of the ring-shaped structure. Since the resistance that occurs when the insertion goes over the recess is thereby reduced, the recess of the support and the protrusion of the path-regulator can be readily positioned.

The above clamp may further include at least one of an attachment for attaching the sheathing material, and a fixing portion to be fixed to a vehicle.

According to this configuration, the path-regulator and the sheathing material can be connected to each other using the clamp. Also, the path-regulator can be connected to a vehicle using the clamp.

A path-regulator that solves the foregoing problem is a path-regulator that is to be used as a constituent member of a wire harness, the wire harness including wires, a sheathing material that is flexible and covers the wires, and a clamp having a support with a ring-shaped structure for supporting the path-regulator, the path regulator including a body that has an axial direction parallel to a path along which the wires are laid out, regulates the path along which the wires are laid out from outside of the sheathing material, and comprises a protrusion or a recess for restricting rotation of the body around an axis thereof by fitting to the ring-shaped structure of the support.

It is preferable that the above body includes the protrusion having a pair of outer side faces that are separate from each other in a circumferential direction of the body, and a leading end face continuous with the pair of outer side faces, wherein an angle formed by one of the pair of outer side faces and the leading end face is greater than an angle formed by the other one of the outer side faces and the leading end face.

According to this configuration, when the protrusion of the body is fitted to the recess of the support by relatively rotating the clamp and the body with respect to each other, one outer side face of the protrusion of the body facilitates fitting of the recess. Thus, the recess of the support can be readily fitted to the protrusion of the body.

A wire harness that solves the foregoing problem includes wires; a sheathing material that is flexible and covers the wires, a path-regulator for regulating a path along which the wires are laid out from outside the sheathing material, due to having an axial direction parallel to the path along which the wires are laid out; and a clamp having a support with a ring-shaped structure for supporting the path-regulator, wherein the path-regulator has a protrusion or a recess, and the ring-shaped structure of the support is configured to restrict rotation of the path-regulator around an axis thereof by fitting to the protrusion or the recess of the path regulator.

According to the present disclosure, the path-regulator for regulating the path of the sheathing material can be supported stably.

### BRIEF DESCRIPTION OF THE DRAWINGS

FIG. 1 is a schematic plan view that shows a wire harness according to a first embodiment.

FIG. 2 is a schematic diagram that shows a layout of the wire harness in a vehicle.

FIG. 3 is a partial cross-sectional view of the wire harness.

FIG. 4 is a partial cross-sectional view of a wire harness according to a second embodiment.

FIG. 5 is a schematic cross-sectional view that illustrates an operation of the clamp.

FIG. 6 is a partial cross-sectional view of a wire harness according to a third embodiment.

FIG. 7 is a schematic cross-sectional view that illustrates an operation of the clamp.

FIG. 8 is a schematic cross-sectional view that illustrates an operation of the clamp.

FIG. 9 is a partial cross-sectional view of a wire harness according to a fourth embodiment.

### DETAILED DESCRIPTION OF EMBODIMENTS

### First Embodiment

The first embodiment of a clamp, a path-regulating member, and a wire harness will be described below.

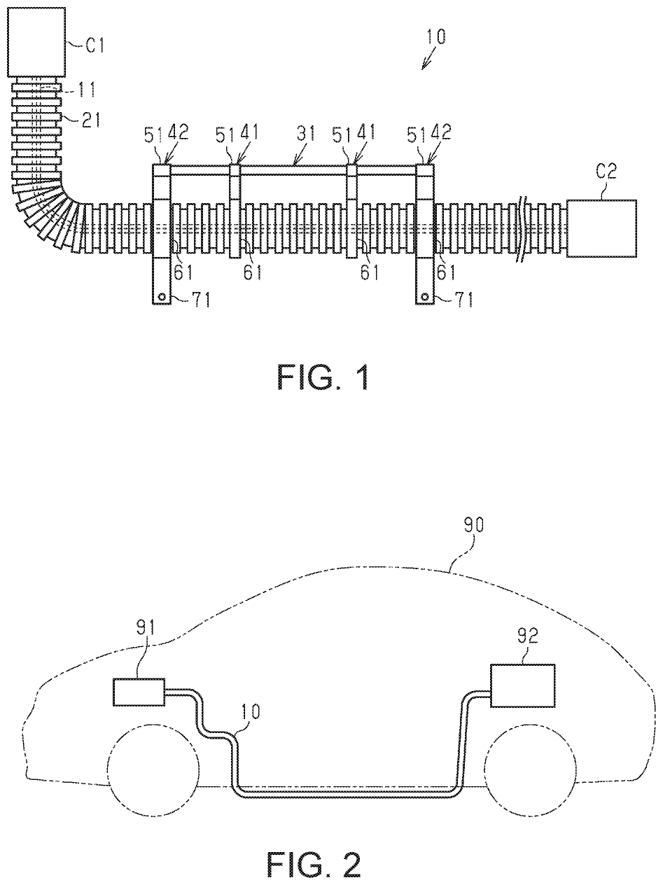

As shown in FIG. 1, a wire harness 10 includes wires 11, a sheathing material 21 that is flexible and covers the wires 11, and a path-regulating member 31 (path regulator) for regulating a path along which the wires 11 are laid out from the outside of the sheathing material 21. Clamps, which are used as constituent materials of the wire harness 10, include first clamps 41 and second clamps 42.

### Layout

As shown in FIG. 2, the wire harness 10 is used to electrically connect a first device 91 and a second device 92, which are mounted in a vehicle 90, to each other. The first device 91 is arranged on the front side of the vehicle 90. The second device 92 is arranged on the rear side of the vehicle 90. For example, one of the first device 91 and the second device 92 is a battery, and the other one is an inverter. Note that, alternatively, one of the first device 91 and the second device 92 may be a motor, and the other one may be an inverter. Examples of the vehicle 90 may include an electric vehicle, a hybrid vehicle, a fuel cell vehicle, and the like. The wire harness 10 according to this embodiment is laid out in an underfloor portion of the vehicle 90.

### Wires 11

Each of the wires 11 has a core wire, which is conductive, and an insulating coating, which is insulative. The core wire is made of a conductive material, such as copper or aluminum, for example. The core wire is constituted by one or more elemental wires. The insulating coating is made of an insulating material, such as polyvinyl chloride, and is formed to have a tubular shape, as is known well.

Two end portions of each wire 11 are constituted by respective connector portions C1 and C2. The wires 11 are high-voltage wires, and are electrically connected to input-output terminals of the first device 91 and the second device 92 that are mounted in the vehicle 90. The rated voltage of high-voltage wires for a vehicle exceeds 30 V in the case of AC voltage, and exceeds 60 V in the case of DC voltage. Note that the rated voltage of high-voltage wires for a vehicle is 600 V at the most in the case of AC voltage, and is 750 V at the most in the case of DC voltage.

The wires 11 may also include a shielding material for shielding the wires 11 from electromagnetic waves, or a shielding material for shielding the wires 11 from electromagnetic waves may be separately arranged at the periphery of the wires 11. A preferable example of the shielding material may be a braided member with a structure in which metal wires made of aluminum, stainless steel, copper, an alloy thereof, or the like are braided into a mesh form.

### Sheathing Material 21

The sheathing material 21 is flexible and can thus be deformed along the path along which the wires 11 are laid out. The sheathing material 21 covers the wires 11 and thus protects the wires 11. The sheathing material 21 is formed to have a tubular shape that has its longitudinal direction, and the wires 11 are arranged in the space within the sheathing material 21. The sheathing material 21 is preferably made of a resin material in terms of weight reduction, for example. Examples of the resin material may include polyolefin, polyamide, polyester, ABS resin, and the like. Specific examples of the sheathing material 21 may include a corrugated tube, a hard resin pipe, and the like. A corrugated tube is preferably used as the sheathing material 21. A corrugated tube has a structure in which a plurality of ring-shaped recessed portions are arranged in the longitudinal direction thereof, and can be readily curved or bent.

The sheathing material 21 may also have a cut line extending in the longitudinal direction. If the sheathing material 21 has a cut line, the wires 11 can be arranged within the sheathing material 21 through the cut line. Note that, if the sheathing material 21 has a cut line, the wires 11 can be prevented from protruding from the cut line by winding a binding material, such as an adhesive tape, around the outer circumference of the sheathing material 21 as needed.

### Path-Regulating Member 31

The axial direction of the path-regulating member 31 is parallel to the path along which the wires 11 are laid out. The path-regulating member 31 is arranged so as to partially regulate the path of the wires 11 from the outside of the sheathing material 21. The number of path-regulating members 31 that constitute the wire harness 10 may be one, or may be more than one. That is to say, a plurality of zones of the wires 11 in the wire harness 10 may be regulated by a plurality of path-regulating members 31, or one zone of the wires 11 may be regulated by one path-regulating member 31. The path-regulating member 31 may be constituted by a straight portion only, or may also have a curved portion.

The path-regulating member 31 can be formed through a cutting process in which a pipe-shaped member or a bar-shaped member is cut to a predetermined length, a curving process in which a tubular member or a bar-shaped member is deformed along the path along which the wires 11 are laid out, or the like, for example. The path-regulating member 31 can also be formed in a mold through injection molding. The path-regulating member 31 is made of a rigid material capable of maintaining the path of the wires 11 arranged within the sheathing material 21. The path-regulating member 31 is preferably made of a material capable of plastic deformation. A metallic material is preferably used as a material of the path-regulating member 31. Examples of the metallic material may include aluminum, iron, copper, an alloy of these metals, and the like, for example. Note that, if the path-regulating member 31 has a pipe shape, a signal line can also be laid out within the path-regulating member 31, for example.

### First Clamp 41 and Second Clamp 42

As shown in FIG. 1, each of the first clamps 41 as a support portion 51 (support) for supporting the path-regulating member 31, and an attachment portion 61 for attaching the sheathing material 21. Each of the second clamps 42 has a support portion 51 for supporting the path-regulating member 31, an attachment portion 61 for attaching the sheathing material 21, and a fixing portion 71 that is to be fixed to the vehicle 90.

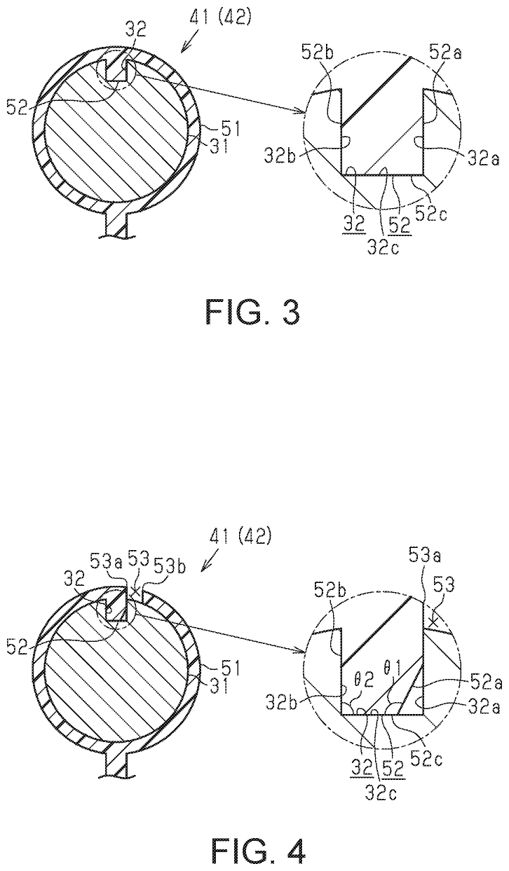

As shown in FIG. 3, each of the support portions 51 of the first clamps 41 and the second clamps 42 has a ring-shaped structure extending along the outer circumference of the path-regulating member 31. The ring-shaped structure of each support portion 51 has a protruding portion 52 (protrusion) that restricts rotation of the path-regulating member 31 around the axis thereof by fitting to a recessed portion 32 (recess) that the path-regulating member 31 has.

Specifically, the protruding portion 52 of the support portion 51 protrudes from an inner face of the ring-shaped structure toward the center thereof. The protruding portion 52 of the support portion 51 has a pair of outer side faces 52a and 52b, which are separate from each other in the circumferential direction of the ring-shaped structure, and a leading end face 52c, which is continuous with the pair of outer side faces 52a and 52b.

The aforementioned recessed portion 32 of the path-regulating member 31 has a pair of inner side faces 32a and 32b, which are separate from each other in the circumferential direction of the path-regulating member 31, and an inner distal face 32c, which is continuous with the pair of inner side faces 32a and 32b.

As a result of the pair of inner side faces 32a and 32b of the recessed portion 32 of the path-regulating member 31 coming into contact with the pair of outer side faces 52a and 52b, respectively, of the protruding portion 52 of the support portion 51, rotation of the path-regulating member 31 around the axis thereof is restricted. The recessed portion 32 of the path-regulating member 31 according to this embodiment extends between two end portions of the path-regulating member 31. Thus, the path-regulating member 31 and the first clamps 41 are allowed to relatively move with respect to each other in the axial direction of the path-regulating member 31. That is to say, in the wire harness 10, the first clamps 41 that support the path-regulating member 31 can move in the axial direction of the path-regulating member 31.

The configuration of the attachment portions 61 of the first clamps 41 and the second clamps 42 is not particularly limited as long as the sheathing material 21 is attached thereby. Each of the attachment portions 61 can be made of, for example, a ring-shaped structure to be fitted to the outer circumference of the sheathing material 21, an adhesive tape to be adhered to an outer-circumferential face of the sheathing material 21, a binding band for binding the sheathing material 21, or the like.

The fixing portion 71 of each second clamp 42 is constituted by an open hole into which a bolt provided in the vehicle 90 is inserted, for example. Although not shown in the diagrams, a bolt provided in the vehicle 90 is inserted into the fixing portion 71 (open hole) of the second clamps 42, and the fixing portion 71 of each second clamp 42 is fixed to the vehicle 90 as a result of a nut being threaded with the bolt. Note that the fixing portion 71 of each second clamp 42 may alternatively be a clip to be locked at an attachment hole provided in the vehicle 90, for example.

The first clamps 41 and the second clamps 42 can be made of a metallic material or a resin material. The first clamps 41 and the second clamps 42 are preferably made of a resin material in terms of weight reduction, for example. Examples of the resin material include polyolefin, polyamide, polyester, ABS resin, and the like.

### Manufacturing Method

Next, an example of a method for manufacturing the wire harness 10 will be described.

To support the path-regulating member 31 using the support portions 51 of the first clamps 41 and the second clamps 42, the path-regulating member 31 is inserted, from one end thereof, into the ring-shaped structure of each support portion 51. At this time, the protruding portion 52 of the support portion 51 is fitted to the recessed portion 32 of the path-regulating member 31. Note that the sheathing material 21 may be attached to the attachment portions 61 of the first clamps 41 and the second clamps 42 either before or after the path-regulating member 31 is supported using the support portions 51 of the first clamps 41 and the second clamps 42. Also, the wires 11 may be arranged within the sheathing material 21 either before or after the sheathing material 21 is attached to the attachment portions 61 of the first clamps 41 and the second clamps 42.

The thus-obtained wire harness 10 preferably includes at least a pair of second clamps 42 that support two end portions of the path-regulating member 31. In this case, the pair of second clamps 42, each of which has the fixing portion 71 to be fixed to the vehicle 90, can stably fix the path-regulating member 31 to the vehicle 90. Note that the path-regulating member 31 can also be fixed to the vehicle 90 using a clamp other than the second clamps 42.

Next, effects of this embodiment will be described.

(1) Each of the first clamps 41 of the wire harness 10 has the support portion 51 with a ring-shaped structure for supporting the path-regulating member 31. The ring-shaped structure of the support portion 51 has the protruding portion 52 that restricts rotation of the path-regulating member 31 around the axis thereof by fitting to the recessed portion 32 of the path-regulating member 31.

According to this configuration, rotation of the path-regulating member 31 around the axis thereof relative to the support portion 51 of each first clamp 41 is restricted. Accordingly, the path-regulating member 31 for regulating the path of the sheathing material 21 can be supported stably. For example, since the support portions 51 of the first clamps 41 will be hardly worn, the path-regulating member 31 can be stably supported by the support portion 51 of each first clamp 41 for a long time. The same effects as those of the support portion 51 of each first clamp 41 can also be achieved by the support portion 51 of each second clamp 42.

(2) The path-regulating member 31 has the recessed portion 32 that is fitted to the protruding portion 52 of each support portion 51 and thus restricts rotation of the path-regulating member 31 around the axis thereof. According to this configuration, rotation of the path-regulating member 31 around the axis thereof relative to the support portion 51 of each first clamp 41 is restricted. Accordingly, the path-regulating member 31 for regulating the path of the sheathing material 21 can be supported stably.

(3) Each of the first clamps 41 and the second clamps 42 has the attachment portion 61 for attaching the sheathing material 21. In this case, the path-regulating member 31 can be connected to the sheathing material 21 using the first clamps 41 and the second clamps 42.

(4) Each of the second clamps 42 has the fixing portion 71 to be fixed to the vehicle 90. In this case, the path-regulating member 31 can be connected to the vehicle 90 using the second clamps 42.

### Second Embodiment

Next, the second embodiment of the clamps, the path-regulating member 31, and the wire harness 10 will be described, mainly regarding differences from the first embodiment. In the second embodiment, the support portions 51 of the first clamps 41 and the second clamps 42 differ from those of the first embodiment.

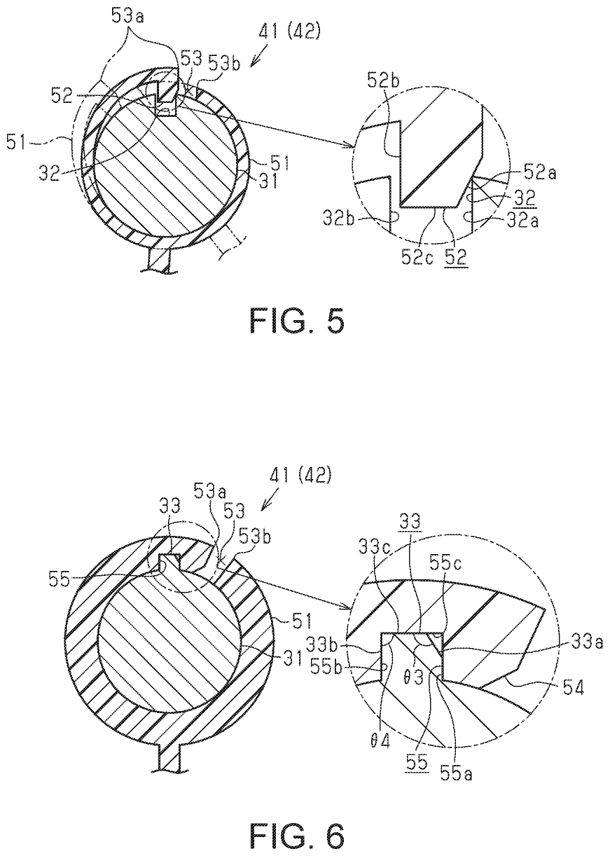

As shown in FIGS. 4 and 5, each of the support portions 51 of the first clamps 41 and the second clamps 42 has an insertion portion 53, which enables the path-regulating member 31 to be inserted therefrom in the radial direction of the ring-shaped structure. That is to say, the ring-shaped structure of the support portion 51 according to this embodiment is a discontinuous ring-shaped structure, and has a first end portion 53a and a second end portion 53b that can be separated from the first end portion 53a. The ring-shaped structure of the support portion 51 can be deformed into an insertion orientation for inserting the path-regulating member 31 from the insertion portion 53 between the first end portion 53a and the second end portion 53b, and a support orientation for supporting the path-regulating member 31. That is to say, the ring-shaped structure of the support portion 51 can be elastically deformed so as to expand the gap between the first end portion 53a and the second end port ion 53b (i.e. the width of the insertion portion 53).

The first end portion 53a has a protruding portion 52 that restricts rotation of the path-regulating member 31 around the axis thereof by fitting to the recessed portion 32 of the path-regulating member 31. The protruding portion 52 has a pair of outer side faces 52a and 52b, which are separate from each other in the circumferential direction of the ring-shaped structure, and a leading end face 52c, which is continuous with the pair of outer side faces 52a and 52b. A first angle θ1 formed by one of the pair of outer side faces 52a and 52b that is located on the insertion portion 53 side, namely the outer side face 52a, and the leading end face 52c is greater than a second angle θ2 formed by the other one of the pair of outer side faces 52a and 52b, namely the outer side face 52b, and the leading end face 52c. The first angle θ1 is preferably set to an angle greater than 90°, and more preferably at least 100°, for example. The second angle θ2 is preferably set to 90° at most.

To support the path-regulating member 31 using the support portions 51 of the first clamps 41 and the second clamps 42 according to this embodiment, the path-regulating member 31 is inserted into the ring of the ring-shaped structure from the insertion portion 53 thereof. Next, as shown in FIG. 5, each first clamp 41 and the path-regulating member 31 are relatively rotated with respect to each other so as to position the support portion 51 from the position indicated by dash-double dot lines to the position indicated by solid lines. Thus, the protruding portion 52 of each support portion 51 is fitted to the recessed portion 32 of the path-regulating member 31, thereby supporting the path-regulating member 31 using the support portion 51.

In this embodiment, the following effects are achieved in addition to the effects described in (1) to (4) in the first embodiment.

(5) The ring-shaped structure of the support portion 51 of each first clamp 41 has the insertion portion 53 that enables the path-regulating member 31 to be inserted therefrom in the radial direction of the ring-shaped structure. In this case, the path-regulating member 31 can be supported by the support portion 51 by inserting an intermediate portion of the path-regulating member 31. Accordingly, for example, even a relatively long path-regulating member 31 can be smoothly supported by the first clamps 41. The same effects as those of the support portions 51 of the first clamps 41 can also be achieved by the support portions 51 of the second clamps 42.

(6) The protruding portion 52 of the support portion 51 of each first clamp 41 has the pair of outer side faces 52a and 52b, which are separate from each other in the circumferential direction of the ring-shaped structure of the support portion 51, and the leading end face 52c, which is continuous with the pair of outer side faces 52a and 52b. The first angle θ1 formed by the outer side face 52a, which is one of the pair of outer side faces 52a and 52b, and the leading end face 52c is greater than the second angle θ2 formed by the outer side face 52b, which is the other one of the pair of outer side faces 52a and 52b, and the leading end face 52c.

In this case, as shown in FIG. 5, when the protruding portion 52 of each support portion 51 is fitted to the recessed portion 32 of the path-regulating member 31 by relatively rotating each first clamp 41 and the path-regulating member 31 with respect to each other, one of the outer side face, namely the outer side face 52a guides the path-regulating member 31 in a direction in which the protruding portion 52 of the support portion 51 is inserted into the recessed portion 32 of the path-regulating member 31. Thus, an operation to fit the protruding portion 52 of the support portion 51 to the recessed portion 32 of the path-regulating member 31 is facilitated. Accordingly, manufacturing of the wire harness 10 is facilitated. The same effects as those of the support portions 51 of the first clamps 41 can also be achieved by the support portions 51 of the second clamps 42.

(7) The first end portion 53a that constitutes the insertion portion 53 of each first clamp 41 has the protruding portion 52. Also, in this embodiment, the first angle θ1 is greater than the second angle θ2, as mentioned above. Here, the first angle θ1 is an angle formed by one outer side face 52a of the protruding portion 52 that is located on the insertion portion 53 side, and the leading end face 52c, and the second angle θ2 is an angle formed by the other outer side face 52b of the protruding portion 52 that is located on the side opposite to the insertion portion 53, and the leading end face 52c.

According to this configuration, as shown in FIG. 4, if force is applied in a direction in which the other outer side face 52b and the inner face 32b are pressed with the protruding portion 52 of the support portion 51 fitted to the recessed portion 32 of the path-regulating member 31, it is difficult for the protruding portion 52 to withdraw from the recessed portion 32 due to the outer side face 52b being hooked on the inner side face 32b. Accordingly, rotation of the path-regulating member 31 around the axis thereof relative to the support portion 51 of each clamp 41 is restricted more preferably. The same effects as those of the support portions 51 of the first clamps 41 can also be achieved by the support portions 51 of the second clamps 42.

### Third Embodiment

Next, the third embodiment of the clamps, the path-regulating member 31, and the wire harness 10 will be described, mainly regarding differences from the first embodiment. In the third embodiment, the configurations of the support portions 51 of the first clamps 41 and the second clamps 42, as well as the path-regulating member 31 differ from those of the first embodiment.

As shown in FIG. 6, each of the support portions 51 of the first clamps 41 and the second clamps 42 has an insertion portion 53, which enables the path-regulating member 31 to be inserted therefrom in the radial direction of the ring-shaped structure. That is to say, the ring-shaped structure of the support portion 51 is a discontinuous ring-shaped structure, and has a first end portion 53a, and a second end portion 53b that can be separated from the first end portion 53a.

In each of the support portions 51 of the first clamps 41 and the second clamps 42, a corner portion between an end face constituting the first end portion 53a, of the first end portion 53a and the second end portion 53b, and an inner-circumferential face of the ring-shaped structure is constituted by a chamfered inclined face 54.

Each of the support portions 51 of the first clamps 41 and the second clamps 42 has a recessed portion 55, which restricts rotation of the path-regulating member 31 around the axis thereof by fitting to a protruding portion 33 that the path-regulating member 31 has. The recessed portion 55 of each support portion 51 is formed in an inner face of the ring-shaped structure. The recessed portion 55 of each support portion 51 has a pair of inner side faces 55a and 55b, which are separate from each other in the circumferential direction of the ring-shaped structure, and an inner distal face 55c, which is continuous with the pair of inner side faces 55a and 55b.

The protruding portion 33 of the path-regulating member 31 extends in the axial direction of the path-regulating member 31. The protruding portion 33 of the path-regulating member 31 has a pair of outer side faces 33a and 33b, which are separate from each other in the circumferential direction of the path-regulating member 31, and a leading end face 33c, which is continuous with the pair of outer side faces 33a and 33b. A third angle 03 formed by the outer side face 33a, which is one of the pair of outer side faces 33a and 33b, and the leading end face 33c is greater than a fourth angle θ4 formed by the outer side face 33b, which is the other one of the pair of outer side faces 33a and 33b, and the leading end face 33c. The third angle θ3 is preferably set to an angle greater than 90°, and more preferably at least 100°, for example. The fourth angle θ4 is preferably set to 90° at most.

To support the path-regulating member 31 using the support portions 51 of the first clamps 41 and the second clamps 42 according to this embodiment, the path-regulating member 31 is inserted into the ring of the ring-shaped structure from the insertion portion 53 thereof.

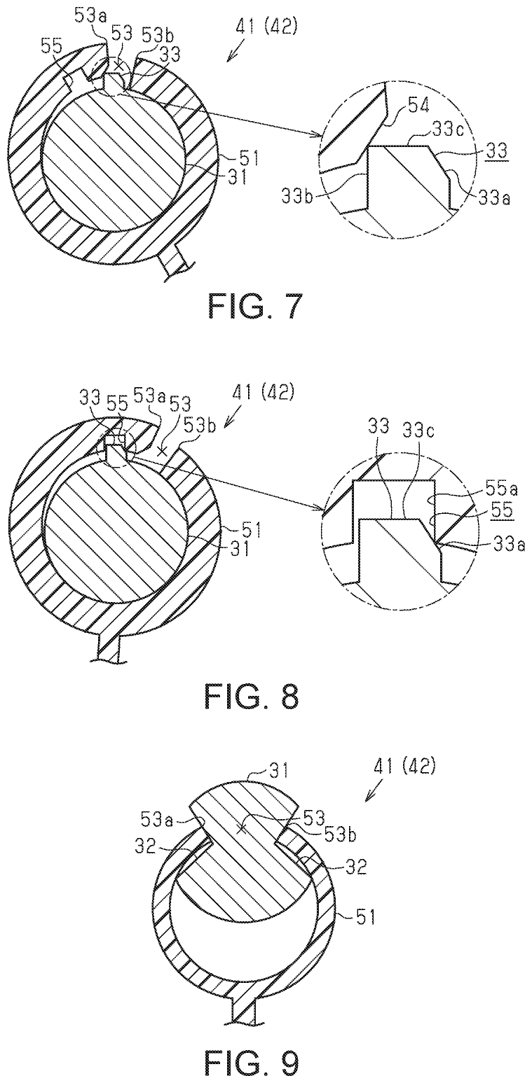

Next, each first clamp 41 and the path-regulating member 31 are relatively rotated with respect to each other, as shown in FIGS. 7 and 8. Thus, the recessed portion 55 of the support portion 51 is fitted to the protruding portion 33 of the path-regulating member 31, thereby supporting the path-regulating member 31 using the support portion 51.

In this embodiment, the following effects are achieved in addition to the effects described in (1) to (4) in the first embodiment and (5) in the second embodiment.

(8) In the support portion 51 of each first clamp 41, the corner portion between the end face constituting the first end portion 53a, of the first end portion 53a and the second end portion 53b, and the inner-circumferential face of the ring-shaped structure is constituted by the chamfered inclined face 54. In this case, when the first clamp 41 and the path-regulating member 31 are relatively rotated with respect to each other to move the insertion portion 53 so as to proceed over the protruding portion 33 of the path-regulating member 31, the inclined face 54 of the support portion 51 comes into sliding contact with the protruding portion 33 of the path-regulating member 31, thereby facilitating expansion of the ring-shaped structure, as shown in FIG. 7. Since resistance that occurs when the insertion portion 53 (first end portion 53a) proceeds over the protruding portion 33 is thereby reduced, the recessed portion 55 of the support portion 51 and the protruding portion 33 of the path-regulating member 31 can be readily positioned. Accordingly, manufacturing of the wire harness 10 is facilitated. The same effects as those of the support portions 51 of the first clamps 41 can also be achieved by the support portions 51 of the second clamps 42.

(9) The protruding portion 33 of the path-regulating member 31 has the pair of outer side faces 33a and 33b, which are separate from each other in the circumferential direction of the path-regulating member 31, and the leading end face 33c, which is continuous with the pair of outer side faces 33a and 33b. The third angle θ3 formed by the outer side face 33a, which is one of the pair of outer side faces 33a and 33b, and the leading end face 33c is greater than the fourth angle θ4 formed by the outer side face 33b, which is the other one of the pair of outer side faces 33a and 33b, and the leading end face 33c.

In this case, when the recessed portion 55 of the support portion 51 is fitted to the protruding portion 33 of the path-regulating member 31 by relatively rotating each first clamp 41 and the path-regulating member 31 with respect to each other, one outer side face 33a of the protruding portion 33 of the path-regulating member 31 facilitates fitting of the recessed portion 55, as shown in FIG. 8. Thus, an operation to fit the recessed portion 55 of the support portion 51 to the protruding portion 33 of the path-regulating member 31 is facilitated. Accordingly, manufacturing of the wire harness 10 is facilitated. The same effects as those of the support portions 51 of the first clamps 41 can also be achieved by the support portions 51 of the second clamps 42.

### Fourth Embodiment

Next, the fourth embodiment of the clamps, the path-regulating member 31, and the wire harness 10 will be described, mainly regarding differences from the first embodiment. In the fourth embodiment, the configurations of the support portions 51 of the first clamps 41 and the second clamps 42, as well as the path-regulating member 31 differ from those of the first embodiment.

As shown in FIG. 9, each of the support portions 51 of the first clamps 41 and the second clamps 42 has an insertion portion 53, which enables the path-regulating member 31 to be inserted therefrom in the radial direction of the ring-shaped structure. That is to say, the ring-shaped structure of the support portion 51 is a discontinuous ring-shaped structure, and has a first end portion 53a, and a second end portion 53b that can be separated from the first end portion 53a.

Each of the support portions 51 of the first clamps 41 and the second clamps 42 according to this embodiment does not have a protruding portion 52 that is described in the first embodiment. The path-regulating member 31 has a pair of recessed portions 32, which are separate from each other in the circumferential direction. Specifically, these two recessed portions 32 of the path-regulating member 31 are arranged at positions opposing to each other in the radial direction of the path-regulating member 31. The pair of recessed portions 32 extends in the axial direction of the path-regulating member 31. The ring-shaped structure of each support portion 51 has a first end portion 53a and a second end portion 53b, which restrict rotation of the path-regulating member 31 around the axis thereof by fitting to the pair of recessed portions 32 of the path-regulating member 31.

In this embodiment, the effects described in (1) to (4) in the first embodiment and the effects described in (5) in the second embodiment are achieved.

The above embodiments may also be modified as follows.

In each of the first clamps 41 and the second clamps 42 according to the respective embodiments, the number of protruding portions or recessed portions to be fitted to the path-regulating member 31 may be more than one. In the path-regulating member 31 in the respective embodiments, the number of protruding portions or recessed portions to be fitted to the ring-shaped structure of each of the support portions 51 of the first clamps 41 and the second clamps 42 may be more than one.

In each of the first clamps 41 or the second clamps 42 in the second embodiment, a protruding portion is formed in the first end portion 53a of the insertion portion 53, but a protruding portion may alternatively be formed at an intermediate portion of the ring-shaped structure that is continuous from the first end portion 53a to the second end portion 53b.

With regard to the path-regulating member 31 in the respective embodiments, for example, the shape of the recessed portions and the protruding portions of the first clamps 41 and the second clamps 42 that support the path-regulating member 31 may also be changed so as to restrict movement of the path-regulating member 31 in the axial direction, in addition to restricting rotation of the path-regulating member 31 around the axis thereof.

The wire harness 10 may employ at least one selected from the first clamps 41 and the second clamps 42.

The wires 11 in the wire harness 10 may alternatively be low-voltage wires, and portions to be electrically connected by the wire harness 10 may also be changed as appropriate.

The constituent elements in the above embodiments and modifications may also be combined.

The sheathing material 21 according to the embodiments is an example of a flexible protective tube. The path-regulating member 31 according to the embodiments is an example of an elongated guide for positioning the sheathing material 21 to a preset layout path. The attachment portion 61 according to the embodiments is an example of a flexible protective tube holder that receives or holds the flexible protective tube (sheathing material 21). The support portion 51 according to the embodiments is an example of a guide grip portion that comes into direct contact with an outer face of the elongated guide (31). The recessed portions 32 and 55 may be key grooves, and the protruding portions 33 and 52 may be keys that fit to the key grooves. Engagement between a key (33; 52) and a key groove (32; 55) enables a clamp (41) to be fixed at a predetermined rotational angle position relative to the axis of the elongated guide (31), and restricts or prevents the clamp (41) from rotating relative to the elongated guide (31). In some examples, the guide grip portion (51) is a tubular body with an open hole that allows the elongated guide (31) to pass therethrough. In other examples, the guide grip portion (51) can be elastically deformed into a non-loop shape (e.g. C shape) that has two opposing ends (53a, 53b) that form a discontinuous portion, which may be a gap (53), therebetween as viewed in the axial direction of the elongated guide (31), and into a loop shape resulting from the two opposing ends (53a, 53b) being connected to each other and the gap (53) being canceled.

The present disclosure encompasses the following implementation examples. The reference numerals of the constituent elements of the embodiments are given, not for the purpose of limitation but to help understanding.

[Note 1] Some implementation examples provide a clamp (41) that is used together with an elongated guide (31) arranged along at least a portion of a layout path, which is preset in a vehicle (90), to position a flexible protective tube (21) for protecting wires (11) in a wire harness (10). This clamp (41) includes:

a guide grip portion (51) that comes into direct contact with an outer face of the elongated guide (31) to attach the clamp (41) to the elongated guide (31); and

a flexible protective tube holder (61) configured to receive a portion of the flexible protective tube (21) to bring the flexible protective tube (21) close to the elongated guide (31), and to regulate a largest separation distance between the portion of the flexible protective tube (21) and the elongated guide (31),

wherein one of the elongated guide (31) and the guide grip portion (51) has a key groove (32; 55), and the other one of the elongated guide (31) and the guide grip portion (51) has a key (33; 52) that fits the key groove (32; 55).

[Note 2] In some implementation examples, the guide grip portion (51) is a tubular body having an open hole that allows the elongated guide (31) to pass therethrough.

[Note 3] In some implementation examples, the guide grip portion (51) can be elastically deformed into

a non-loop shape that may be a C shape and has two ends (53a, 53b) opposing to form a discontinuous portion, which may be a gap (53), therebetween as viewed in an axial direction of the elongated guide (31), and

a loop shape resulting from the two opposing ends (53a, 53b) being connected to each other and the gap (53) being canceled.

[Note 4] In some implementation examples, the key (52) is provided in one of the two ends (53a, 53b) of the guide grip portion (51).

It will be apparent for a person skilled in the art that the present disclosure may be embodied in other unique mode without departing from the technical idea thereof. For example, some of the components described in the embodiments (or one or more modes thereof) may be omitted, or may be combined.

1. A clamp that is to be used as a constituent member of a wire harness,
the wire harness including wires, a sheathing material that is flexible and covers the wires, and a path regulator for regulating a path along which the wires are laid out from outside of the sheathing material, the path regulator having an axial direction parallel to the path along which the wires are laid out,
the clamp comprising:
a support with a ring-shaped structure for supporting the path regulator,
wherein the ring-shaped structure of the support is configured to restrict rotation of the path regulator around an axis thereof and to allow relative movement of the path regulator and the clamp in the axial direction by fitting to a protrusion or a recess of the path regulator.

2. The clamp according to claim 1,
wherein the ring-shaped structure has an insertion that enables the path regulator to be inserted therefrom in a radial direction of the ring-shaped structure.

3. The clamp according to claim 2,
wherein the ring-shaped structure has a protrusion to be fitted to the recess of the path regulator, and
the protrusion of the ring-shaped structure has a pair of outer side faces that are separate from each other in a circumferential direction of the ring-shaped structure, and a leading end face continuous with the pair of outer side faces, and an angle formed by one of the pair of outer side faces and the leading end face is greater than an angle formed by the other one of the outer side faces and the leading end face.

4. The clamp according to claim 3,
wherein a corner between an end face forming at least one of two ends forming the insertion of the ring-shaped structure and an inner-circumferential face of the ring-shaped structure is chamfered.

5. The clamp according to claim 1, further comprising:
at least one of an attachment for attaching the sheathing material, and a fixing portion to be fixed to a vehicle.

6. A path regulator that is to be used as a constituent member of a wire harness,
the wire harness including wires, a sheathing material that is flexible and covers the wires, and a clamp having a support with a ring-shaped structure for supporting the path regulator, the path regulator comprising:
a body that has an axial direction parallel to a path along which the wires are laid out, regulates the path along which the wires are laid out from outside of the sheathing material, and comprises a protrusion or a recess for restricting rotation of the body around an axis thereof and for allowing relative movement of the body and the clamp in the axial direction by fitting to the ring-shaped structure of the support.

7. The path regulator according to claim 6, comprising:
the protrusion having a pair of outer side faces that are separate from each other in a circumferential direction of the body, and a leading end face continuous with the pair of outer side faces,
wherein an angle formed by one of the pair of outer side faces and the leading end face is greater than an angle formed by the other one of the outer side faces and the leading end face.

8. A wire harness comprising:
wires;
a sheathing material that is flexible and covers the wires,
a path regulator for regulating a path along which the wires are laid out from outside the sheathing material, due to having an axial direction parallel to the path along which the wires are laid out; and
a clamp having a support with a ring-shaped structure for supporting the path regulator,
wherein the path regulator has a protrusion or a recess, and
the ring-shaped structure of the support is configured to restrict rotation of the path regulator the around an axis thereof and to allow relative movement of the path regulator and the clamp in the axial direction by fitting to the protrusion or the recess of the path regulator.
